(19) United States
(12) Patent Application Publication
(10) Pub. No.: US 2025/0260235 A1
(43) Pub. Date: Aug. 14, 2025

(54) DISSOCIATED MICROGRID CONTROLLER

(71) Applicant: Caterpillar Inc., Peoria, IL (US)

(72) Inventors: Srideep Chatterjee, Bhopal (IN); Ranjay Singh, Kanpur (IN); Bantupalli Manoj Kumar, WhiteField (IN); Ayush Sharan, Bengaluru (IN)

(73) Assignee: Caterpillar Inc., Peoria, IL (US)

(21) Appl. No.: 18/436,168

(22) Filed: Feb. 8, 2024

(51) Int. Cl. H02J 3/38; H02J 3/14

(52) U.S. Cl. CPC H02J 3/381; H02J 3/14; H02J 2203/10; H02J 2300/20

(57) ABSTRACT

Microgrid control techniques that combine the benefits of both rule-based and optimizer-based approaches. The techniques are flexible enough to find optimal or near-optimal economic dispatch solutions based on real-time conditions, but that is also deterministic by always reliably calculating a result within a guaranteed timeframe. These techniques provide the optimality of optimizer methods along with the reliability of rule-based methods for microgrid control.

### TECHNICAL FIELD

This disclosure relates generally to techniques for controlling the dispatch of power in a microgrid.

### BACKGROUND

Microgrid controllers stand central in the operation and optimization of microgrids, functioning as the brain of the system. These sophisticated control systems manage the microgrid's operation, both in grid-connected and islanded modes, ensuring optimal power quality and reliability. They are critical for real-time decision-making, primarily balancing power supply and demand, managing distributed energy resources (DERs), and controlling energy storage systems. Their advanced algorithms enable the dynamic dispatch of power, ensuring that the right amount of electricity is generated at the right time, reducing waste and improving efficiency. In the context of varying renewable energy production, due to its dependency on weather conditions, microgrid controllers are particularly crucial. They swiftly counteract fluctuations in power output by dispatching available assets effectively, maintaining the stability and reliability of the microgrid.

The intricacy of power dispatch in microgrids lies in the simultaneous coordination of multiple types of resources, such as photovoltaic panels, wind turbines, combined heat and power units, and energy storage systems like batteries or flywheels. Microgrid controllers must continually analyze data on electricity demand, resource availability, energy prices, and weather forecasts to make informed decisions on power generation, consumption, and storage. They also play a pivotal role in demand response strategies, adjusting demand to match supply during peak usage or supply shortage periods. Furthermore, with the advent of advanced machine learning algorithms and real-time data processing, microgrid controllers have evolved to predict potential energy gaps and automate the dispatching process, thus optimizing resource use, minimizing costs, and reducing greenhouse gas emissions. Their adaptability and foresight ensure the resilience and sustainability of microgrids in an era of increasing energy demands and climate-related challenges.

U.S. Pat. No. 9,564,757 describes an apparatus that optimizes a hybrid power system with respect to long-term characteristics of the hybrid power system. The apparatus includes a real-time controller of the hybrid power system and a processor. The processor cooperates with the real-time controller and is structured to input current measurements of information from the hybrid power system and hybrid dynamics information including continuous dynamics and discrete time dynamics that model the hybrid power system. The processor provides online optimization of the hybrid power system based upon the input, and outputs a power flow reference and a number of switch controls to the real-time controller based upon the online optimization. The processor is further structured to provide at least one of: real-time forecasts or real-time prediction of future information operatively associated with the hybrid power system as part of the input, and real-time processing of the online optimization.

### SUMMARY

This disclosure describes microgrid control techniques that combine the benefits of both rule-based and optimizer-based approaches. The techniques are flexible enough to find optimal or near-optimal economic dispatch solutions based on real-time conditions, but that is also deterministic by always reliably calculating a result within a guaranteed timeframe. These techniques provide the optimality of optimizer methods along with the reliability of rule-based methods for microgrid control.

In some aspects, this disclosure is directed to a system for controlling a microgrid, the system comprising: a real-time controller configured to receive current operating conditions of the microgrid and determine a dispatch of power among assets of the microgrid using a deterministic control strategy; and a long-term controller in communication with the real-time controller and configured to: receive past, current, and forecasted operating conditions of the microgrid; generate, based on the past, the current, and the forecasted operating conditions, data representing adjustments to the deterministic control strategy of the real-time controller; and provide the data to the real-time controller to adjust the deterministic control strategy.

In some aspects, this disclosure is directed to a method for controlling a microgrid, the method comprising: receiving past, current, and forecasted operating conditions of the microgrid; generating, based on the past, the current, and the forecasted operating conditions, data representing adjustments to a deterministic control strategy of a real-time controller; providing data to a real-time controller to adjust the deterministic control strategy; and receiving 1) the data representing the adjustments to the deterministic control strategy and 2) current operating conditions of the microgrid and, in response, determining a dispatch of power among assets of the microgrid using the deterministic control strategy.

In some aspects, this disclosure is directed to a system for controlling a first microgrid and a second microgrid, the system comprising: a first real-time controller configured to receive current operating conditions of the first microgrid and determine a dispatch of power among assets of the first microgrid using a first deterministic control strategy; and a second real-time controller configured to receive current operating conditions of the second microgrid and determine a dispatch of power among assets of the second microgrid using a second deterministic control strategy; a long-term controller in bidirectional communication with the real-time controller and configured to: receive past, current, and forecasted operating conditions of the microgrid; generate, based on the past, the current, and the forecasted operating conditions, data representing adjustments to the first deterministic control strategy of the first real-time controller and to the second deterministic control strategy of the second real-time controller; provide the data to the first real-time controller to adjust the first deterministic control strategy and to the second real-time controller to adjust the second deterministic control strategy; receive feedback data from the first real-time controller and the second real-time controller representing a corresponding performance of the first deterministic control strategy and the second deterministic control strategy; and generate, based on the feedback data, updated data representing adjustments to the first deterministic control strategy of the first real-time controller and to the second deterministic control strategy of the second real-time controller.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for controlling a microgrid in accordance with this disclosure.

FIG. 2 is a block diagram of another example of a system for controlling a microgrid in accordance with this disclosure.

FIG. 3 is a flow diagram depicting an example of a method for controlling a microgrid in accordance with this disclosure.

### DETAILED DESCRIPTION

The inventors have identified limitations with current microgrid controller approaches for calculating optimal economic dispatch of power. Microgrid controllers that dispatch power for economic energy and operating costs traditionally use rule-based or optimizer-based approaches to calculating the optimal dispatch. However, both approaches have their drawbacks. Rule based methods are rigid and may not always provide the most optimal solution, however they are deterministic and will always reliably calculate an output. Optimizer based methods may potentially be flexible to real-time conditions and provide a more optimum solution, however they may not always converge in the desired time and hence may be non-deterministic.

This disclosure describes microgrid control techniques that combine the benefits of both rule-based and optimizer-based approaches. The techniques are flexible enough to find optimal or near-optimal economic dispatch solutions based on real-time conditions, but that is also deterministic by always reliably calculating a result within a guaranteed timeframe. These techniques provide the optimality of optimizer methods along with the reliability of rule-based methods for microgrid control.

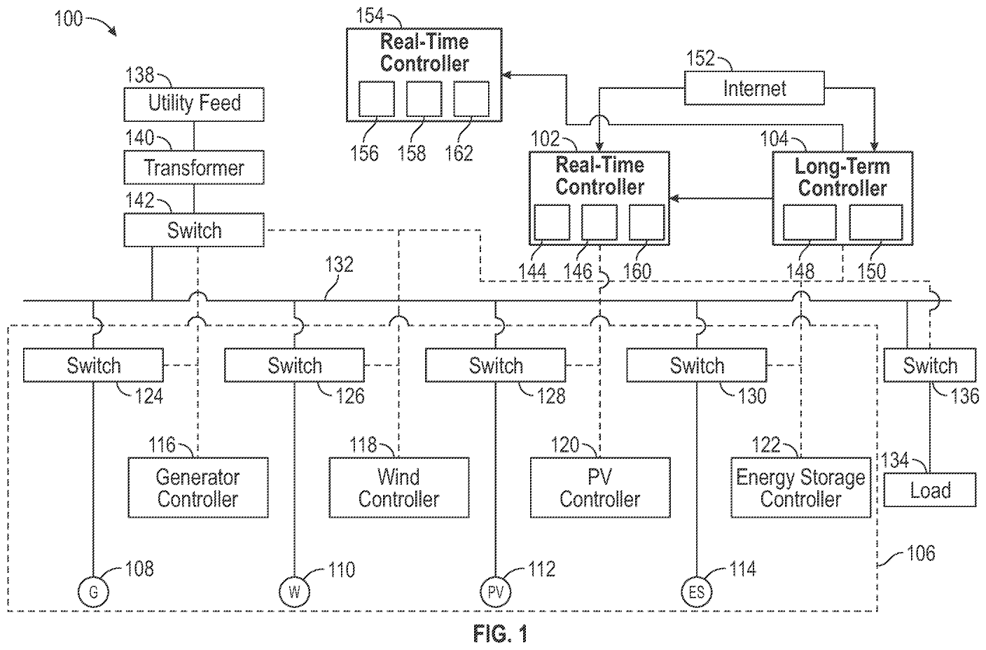

FIG. 1 is a block diagram of an example of a system 100 for controlling a microgrid in accordance with this disclosure. The techniques of this disclosure split the control logic for the microgrid into two dissociated sections: 1) a real-time controller that uses deterministic techniques to calculate the power dispatch at a fast rate and 2) a long-term controller that optimizes the control strategy of the real-time controller over a longer time duration.

The microgrid 106 of the system 100 includes one or more distributed energy resources (DER) assets, such as one or more generators 108 (also referred to as a genset), one or more wind turbines 110, one or more photovoltaic (PV) arrays 112 (also referred to as photovoltaic panels), and/or one or more energy storage banks 114, such as including batteries or capacitors, that may source and sink electrical power. Each of the DER assets present are coupled to a corresponding controller, such as a generator controller 116, a wind controller 118 (e.g., an AC/AC converter), PV controller 120 (e.g., a DC/AC converter), and an energy storage controller 122. The DER assets are coupled to a common bus 132 via one of the corresponding switches 124-130.

Each of the generator controller 116, the wind controller 118, the PV controller 120, and the energy storage controller 122 may be located in close proximity to the corresponding DER asset and may have a separate communication network (shown in dashed line). A load 134 may be coupled to the bus 132 via a switch 136.

An electric utility feed 138 is coupled with the common bus 132 via a transformer 140 and a switch 142. In some examples, the utility feed 138 may act as the primary source of electrical power delivered to the load 134 and the DER assets of the microgrid 106 may act as the secondary source of electrical power delivered to the load 134.

As mentioned above, to combine the benefits of both rule-based and optimizer-based approaches, the system 100 includes a real-time controller 102 and a long-term controller 104. The real-time controller 102 may process the current information and calculate an optimum dispatch of power for the current time based on its control strategy. The long-term controller 104 may process past, current, and future forecasted information and calculate the changes to the real-time controller's control strategy, such that the real-time controller 102 may calculate the optimum dispatch at different operating conditions. The control strategy of the real-time controller 102 is tunable and therefore is responsive to changing operating conditions like weather, utility pricing forecasts, and load forecasts.

The real-time controller 102 includes a processor 144 coupled with a memory device 146 comprising instructions that, when executed, cause the processor 144 to perform the functionality described with respect to the real-time controller 102. The real-time controller 102 may receive current operating conditions of the microgrid 106. For example, the real-time controller 102 is in communication with the various controllers of the microgrid 106, such as the generator controller 116, the wind controller 118, the PV controller 120, and the energy storage controller 122. Each of these controllers may provide information, such as current power generation, or in the case of the energy storage 114, the available power stored, to the real-time controller 102. The real-time controller 102 may use this information to determine a dispatch of power among assets of the microgrid using a deterministic control strategy.

For example, if it is not windy and the wind turbines 110 are not producing much electricity but it is sunny and the PV arrays 112 are producing electricity, the real-time controller 102 may determine a dispatch of power that favors use of the PV arrays 112 over the wind turbines 110. As another example, it is more economical for the real-time controller 102 to choose to use renewable energy from the PV arrays 112 instead of burning fuel to supply the generators 108. So, using a deterministic control strategy, the real-time controller 102 may determine how much power the load 134 is consuming and, if possible, turn off the generators 108 and use the PV arrays 112 to supply power to the load 134. The real-time controller 102 may also determine, based on the load 134 and a state of charge of the battery modules, if the PV arrays 112 may also charge battery modules of the energy storage banks 114. In this manner, the real-time controller 102 may determine a dispatch of power based on economics, for example. Whenever the load changes, the real-time controller 102 may determine, for example, that a particular one (or more) of the DER assets is best suited in terms of operating costs, emissions, or some other criteria, to supply power to the load 134.

The long-term controller 104 provides an optimizer-based approach. For example, the long-term controller 104 may receive the cost of generating one kilowatt from the PV arrays 112, the cost of generating one kilowatt from the generator 108, and the cost of generating one kilowatt from the energy storage banks 114 and then perform various calculations to generate data to reduce or minimize a cost per kilowatt for at least one of the DER assets, which thereby optimizes the power dispatch of each asset.

The long-term controller 104 includes a processor 148 and a memory device 150 comprising instructions that, when executed, cause the processor 148 to perform the functionality described with respect to the real-time long-term controller 104. The long-term controller 104 may receive past, current, and forecasted operating conditions of the microgrid, such as one or more of weather, load, and electric pricing. For example, the long-term controller 104 may receive past and/or forecasted operating conditions via a connection to the internet 152. The long-term controller 104 may receive cost information, e.g., cost per kilowatt, for each of the DER assets.

The long-term controller 104 may also receive current operating conditions in a manner similar to that of the real-time controller 102. That is, the long-term controller 104 is in communication with the various controllers of the microgrid 106, such as the generator controller 116, the wind controller 118, the PV controller 120, and the energy storage controller 122. The long-term controller 104 may generate, based on the past, the current, and/or the forecasted operating conditions, data representing adjustments to the deterministic control strategy of the real-time controller. Then, the long-term controller 104 may provide the data to the real-time controller 102 to adjust the deterministic control strategy.

By way of a non-limiting example, because rain is forecasted from 12:00 PM to 1:00 PM, the long-term controller 104 provides data to the real-time controller 102 that indicates that the real-time controller 102 should use a set of rules or tunes (or weights and biases for a neural network) that work better with lower amounts of solar. In this way, the long-term controller 104 does not specify to the real-time controller 102 to change the dispatch to the assets. Rather, the long-term controller 104 tells the real-time controller 102 to use a different strategy at different times, which automatically adjusts the dispatch of the assets, such as a genset in this example. The techniques of this disclosure modify the behavior of the real-time controller 102 so that it may perform at its best under changing circumstances. The long-term controller 104 does not provide data for the assets themselves to the real-time controller 102; rather, the long-term controller 104 provides data to adjust the deterministic control strategy.

In some examples, the deterministic control strategy of the real-time controller 102 includes a neural network 160. The data provided to the real-time controller by the long-term controller may include adjustments to at least one of a weight and a bias of the neural network 160. In other examples, the deterministic control strategy includes a rule-based control strategy, such as an “if-then-else” rule-based control strategy.

In some examples, the long-term controller 104 provides data to a plurality of real-time controllers. For example, in FIG. 1, the long-term controller 104 provides data to both the real-time controller 102 and the real-time controller 154, such as including a neural network 162. In other examples, the long-term controller 104 provides data to more than two real-time controllers.

One long-term controller may provide data to multiple real-time controllers to test strategies. For example, the long-term controller may include a feedback loop to update its own parameters based on predicted versus actual performance. Forecasting the load or using weather forecasts is an example of a long-term controller updating its own parameters. If the actual load or weather differs substantially from the forecast, the long-term controller may adjust its own forecasting algorithms.

In some examples, the data provided to the real-time controller includes a schedule of times. The real-time controller, such as the real-time controller 102, is configured to adjust its deterministic control strategy using the schedule of times.

In some examples, the long-term controller 104 provides the same data to both the real-time controller 102 and the real-time controller 154. In other examples, the long-term controller 104 provides first data to the real-time controller 102 and second data to the real-time controller 154, where the second data is different than the first data.

The real-time controllers may operate without any input from the long-term controller 104. The input from the long-term controller 104 is used only to improve the existing functionality of the real-time controller, such that the behaviors of the real-time controller may change over longer time horizons. As such, the real-time controllers, such as the real-time controller 102, are configured to operate independently using the deterministic control strategy in the absence of updates from the long-term controller 104.

By using these techniques, the long-term controller 104 tunes the parameters of the real-time controller, such as the real-time controller 102. So, the real-time controller directly controls the DER assets, but its strategy is optimized by the long-term controller.

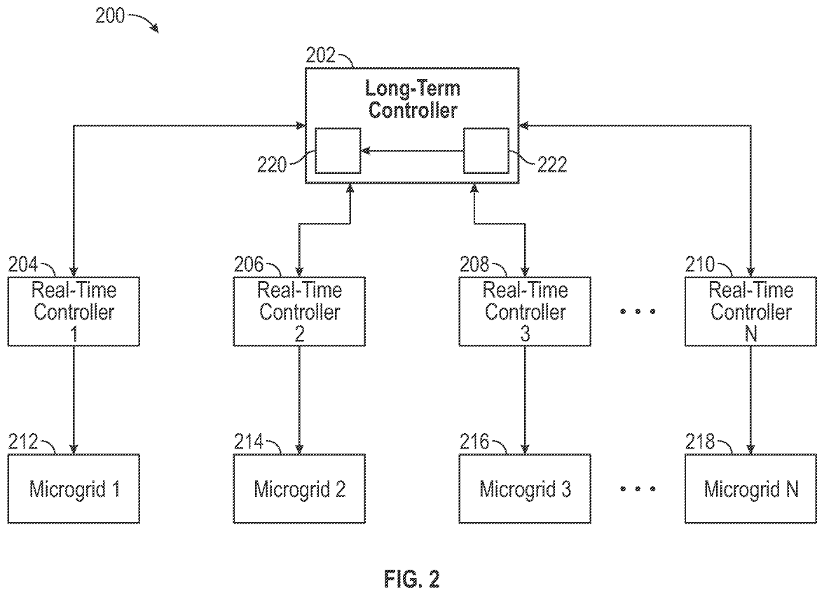

In some examples, the system may use feedback to modify its strategy, such as described below with respect to FIG. 2.

FIG. 2 is a block diagram of another example of a system 200 for controlling a microgrid in accordance with this disclosure. The system 200 includes a long-term controller 202 in bi-directional communication with N real-time controllers, shown as real-time controller 1 204, real-time controller 2 206, real-time controller 3 208, and so forth up to the real-time controller N 210. Each real-time controller is in communication with a corresponding microgrid: the real-time controller 1 204 is in communication with a microgrid 1 212, the real-time controller 2 206 is in communication with a microgrid 2 214, the real-time controller 3 208 is in communication with a microgrid 3 216, and so forth up to the real-time controller N 210 is in communication with a microgrid N 218. Each microgrid includes various DER assets and the amount and type of DER assets may differ between microgrids. For example, the microgrid 1 212 may include 5 gensets, 10 PV arrays, 1 wind turbine, and the microgrid 2 214 may include 1 genset, 5 PV arrays, and 5 wind turbines.

Each real-time controller manages DER assets within its assigned local microgrid, including combinations of generators, PV arrays, wind turbines, etc. The long-term controller 202 communicates bidirectionally with all real-time controllers. The long-term controller 202 utilizes current and historical operating data to forecast weather, electricity pricing, load demand, and other conditions. The long-term controller incorporates predictive capabilities through external data feeds or internal analytics.

Using its forecasts, the long-term controller 202 generates optimized control strategies, such as by tuning parameters like weights and biases in the real-time controllers' neural networks. Strategies are tailored to each microgrid's assets and geography, with the goal of minimizing costs and maximizing utilization efficiency.

Using various techniques of this disclosure, the system 200 of FIG. 2 may utilize performance feedback from the real-time controllers to the long-term controller 202 to continually enhance and optimize control strategies. For example, the long-term controller 202 deploys different strategy versions to various real-time controllers, then evaluates their effectiveness based on measured data communicated from the real-time controllers, and strategies that perform better are identified. In some examples, the long-term controller's neural network training process is updated to generate more recommendations similar to the top performers. This constant feedback loop of trying strategies, evaluating outcomes, and adjusting internal algorithms allows the system 200 to continually boost strategy quality over time without needing additional hierarchical control layers. In essence, localized real-time control is maintained, while global optimization occurs through ongoing performance benchmarking and machine learning refinement.

The long-term controller 202 may test different versions of a strategy by deploying them to different real-time controllers. Using performance feedback, the long-term controller 202 determines the most effective strategies and modifies its internal training algorithm 222 to generate more recommendations similar to the best performers via its neural network 220, for example.

The training algorithm 222 in the long-term controller 202 may function as a “strategy creator” that generates specialized strategies for different conditions. By way of a non-limiting example, the system 200 may create multiple rain strategies to deal with weather events. For example, the real-time controller 1 204 implemented “Rain Strategy Version 1” during a rainstorm and provided performance feedback to the long-term controller 202 on how well that strategy worked. Similarly, the real-time controller 2 206 implemented “Rain Strategy Version 2” during the rainstorm and provided performance feedback to the long-term controller 202 on how well that strategy worked.

By analyzing the feedback from the two real-time controllers, the long-term controller 202 determined that “Rain Strategy Version 2” used by the real-time controller 2 206 worked better. Based on this analysis, the training algorithm 222 is modified to produce strategies similar to “Rain Strategy Version 2”. By monitoring results and continually improving, the long-term controller 202 optimizes control strategies without the need for additional hierarchical control layers. The long-term controller 202 uses these strategies to generate adjustments to the deterministic control strategies of the real-time controllers, such as adjustments to the weights and bias, for example.

In this manner, a first real-time controller, such as the real-time controller 1 204, and a second real-time controller, such as the real-time controller 2 206, are configured to provide feedback to the long-term controller 202, where the feedback is data representing a corresponding performance of the first deterministic control strategy and the second deterministic control strategy. The long-term controller 202 is configured to generate, based on the feedback, the data representing adjustments to a first deterministic control strategy of the first real-time controller and to a second deterministic control strategy of the second real-time controller.

Using these techniques, real-time microgrid asset control remains local, while the long-term controller 202 leverages neural network training, performance feedback, and perpetual self-improvement to provide adaptive, customized strategies to each real-time controller.

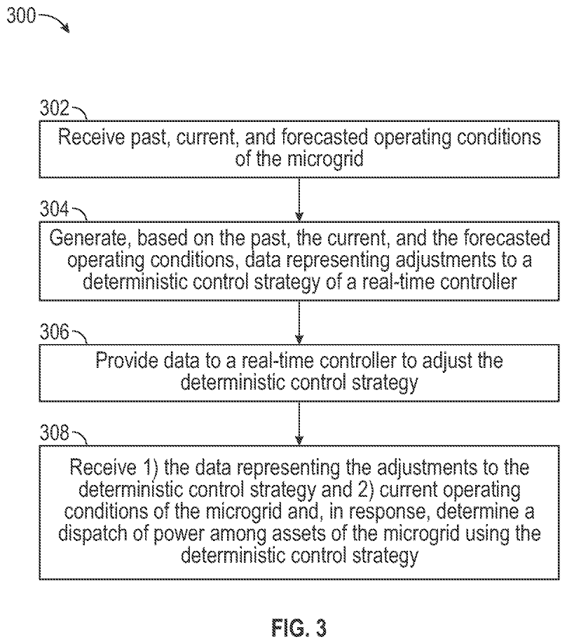

FIG. 3 is a flow diagram depicting an example of a method 300 for controlling a microgrid in accordance with this disclosure. At block 302, the method 300 includes receiving past, current, and forecasted operating conditions of the microgrid.

In block 304, the method 300 includes generating, based on the past, the current, and the forecasted operating conditions, data representing adjustments to a deterministic control strategy of a real-time controller.

At block 306, the method 300 includes providing data to a real-time controller to adjust the deterministic control strategy. In some examples, providing the data to a real-time controller to adjust the deterministic control strategy includes providing adjustments to at least one of a weight or a bias of a neural network of the real-time controller.

At block 308, the method 300 includes receiving 1) the data representing the adjustments to the deterministic control strategy and 2) current operating conditions of the microgrid and, in response, determining a dispatch of power among assets of the microgrid using the deterministic control strategy.

In some examples, the real-time controller includes a plurality of real-time controllers, and the method includes providing, via the long-term controller, the data to each of the plurality of real-time controllers. In some such examples, the data includes first data and second data, where the first data is different than the second data, and where providing, via the long-term controller, the data to each of the plurality of real-time controllers includes providing, via the long-term controller, the first data to a first one of the plurality of real-time controllers and the second data to a second one of the plurality of real-time controllers.

### INDUSTRIAL APPLICABILITY

The microgrid control techniques described above have significant industrial applicability for optimizing power dispatch and costs in microgrid systems. Microgrids are self-contained power systems composed of distributed energy resources and loads that may disconnect from and reconnect to the main grid.

With the growth in renewable energy sources such as solar and wind power, microgrids are becoming increasingly prevalent for military bases, universities, hospitals, and remote communities aiming for energy resiliency and sustainability. The economic optimization of power generation, storage, and load is crucial for these microgrids to minimize costs and maximize utilization of resources.

The microgrid control techniques of this disclosure provide a flexible and reliable way to achieve optimal economic dispatch. By leveraging both rule-based and optimizer-based approaches, it may adapt to real-time operating conditions while guaranteeing a solution within time constraints. This dispatch optimization will enable industrial microgrid operators to significantly reduce energy costs and improve system performance.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A system for controlling a microgrid, the system comprising:
a real-time controller configured to receive current operating conditions of the microgrid and determine a dispatch of power among assets of the microgrid using a deterministic control strategy; and
a long-term controller in communication with the real-time controller and configured to:
receive past, current, and forecasted operating conditions of the microgrid;
generate, based on the past, the current, and the forecasted operating conditions, data representing adjustments to the deterministic control strategy of the real-time controller; and
provide the data to the real-time controller to adjust the deterministic control strategy.

2. The system of claim 1, wherein the real-time controller includes a plurality of real-time controllers, and wherein the long-term controller is configured to provide the data to each of the plurality of real-time controllers.

3. The system of claim 2, wherein the data includes first data and second data, wherein the long-term controller is configured to provide the first data to a first one of the plurality of real-time controllers and the second data to a second one of the plurality of real-time controllers, and wherein the first data is different than the second data.

4. The system of claim 1, wherein the real-time controller is configured to operate independently using the deterministic control strategy in the absence of updates from the long-term controller.

5. The system of claim 1, wherein the deterministic control strategy of the real-time controller includes a neural network.

6. The system of claim 5, wherein the data provided to the real-time controller by the long-term controller includes adjustments to at least one of a weight or a bias of the neural network.

7. The system of claim 1, wherein the long-term controller configured to provide the data to the real-time controller is configured to:
increase the dispatch of power of a first asset of the microgrid.

8. The system of claim 1, wherein the long-term controller configured to provide the data to the real-time controller is configured to:
decrease the dispatch of power of a first asset of the microgrid.

9. The system of claim 1, wherein the data provided to the real-time controller includes a schedule, and
wherein the real-time controller is configured to adjust the deterministic control strategy of the real-time controller using the schedule.

10. The system of claim 1, wherein the assets include one or more of a generation set, a wind turbine, a photovoltaic panel, and an energy storage system.

11. The system of claim 1, wherein the long-term controller configured to generate, based on the past, the current, and the forecasted operating conditions, the data representing the adjustments to the deterministic control strategy of the real-time controller is configured to:
generate data to reduce or minimize a cost per kilowatt for at least one of the assets.

12. The system of claim 1, wherein the past, the current, and the forecasted operating conditions of the microgrid includes one or more of weather, load, and electric pricing.

13. The system of claim 1, wherein the long-term controller is in bidirectional communication with the long-term controller, and wherein the long-term controller is configured to adjust the deterministic control strategy based on feedback from the real-time controller.

14. The system of claim 13, wherein the real-time controller is a first real-time controller, and wherein the microgrid is a first microgrid, and wherein the deterministic control strategy is a first deterministic control strategy, the system comprising:
a second real-time controller configured to receive current operating conditions of a second microgrid and determine a dispatch of power among assets of the microgrid using a second deterministic control strategy,
wherein the first real-time controller and the second real-time controller are configured to provide feedback to the long-term controller, and
wherein the long-term controller is configured to generate, based on the feedback, the data representing adjustments to the first deterministic control strategy of the first real-time controller and to the second deterministic control strategy of the second real-time controller.

15. A method for controlling a microgrid, the method comprising:
receiving past, current, and forecasted operating conditions of the microgrid;
generating, based on the past, the current, and the forecasted operating conditions, data representing adjustments to a deterministic control strategy of a real-time controller;
providing data to a real-time controller to adjust the deterministic control strategy; and
receiving 1) the data representing the adjustments to the deterministic control strategy and 2) current operating conditions of the microgrid and, in response, determining a dispatch of power among assets of the microgrid using the deterministic control strategy.

16. The method of claim 15, wherein the real-time controller includes a plurality of real-time controllers, the method comprising:
providing, via the long-term controller, the data to each of the plurality of real-time controllers.

17. The method of claim 16, wherein the data includes first data and second data, wherein the first data is different than the second data, and wherein providing, via the long-term controller, the data to each of the plurality of real-time controllers includes:
providing, via the long-term controller, the first data to a first one of the plurality of real-time controllers and the second data to a second one of the plurality of real-time controllers.

18. The method of claim 15, wherein providing the data to a real-time controller to adjust the deterministic control strategy includes:
providing adjustments to at least one of a weight or a bias of a neural network of the real-time controller.

19. A system for controlling a first microgrid and a second microgrid, the system comprising:
a first real-time controller configured to receive current operating conditions of the first microgrid and determine a dispatch of power among assets of the first microgrid using a first deterministic control strategy; and
a second real-time controller configured to receive current operating conditions of the second microgrid and determine a dispatch of power among assets of the second microgrid using a second deterministic control strategy;
a long-term controller in bidirectional communication with the real-time controller and configured to:
receive past, current, and forecasted operating conditions of the microgrid;
generate, based on the past, the current, and the forecasted operating conditions, data representing adjustments to the first deterministic control strategy of the first real-time controller and to the second deterministic control strategy of the second real-time controller;
provide the data to the first real-time controller to adjust the first deterministic control strategy and to the second real-time controller to adjust the second deterministic control strategy;
receive feedback data from the first real-time controller and the second real-time controller representing a corresponding performance of the first deterministic control strategy and the second deterministic control strategy; and
generate, based on the feedback data, updated data representing adjustments to the first deterministic control strategy of the first real-time controller and to the second deterministic control strategy of the second real-time controller.

20. The system of claim 19, wherein the data provided to the first real-time controller or the second real-time controller by the long-term controller includes adjustments to at least one of a weight or a bias of a neural network.
